(19) United States
(12) Patent Application Publication
(10) Pub. No.: US 2014/0050931 A1
(43) Pub. Date: Feb. 20, 2014

(54) Directly Metallizable Polyarylene Sulfide Composition

(71) Applicant: Ticona LLC, Florence, KY (US)

(72) Inventor: Ke Feng, Cincinnati, OH (US)

(73) Assignee: Ticona LLC, Florence, KY (US)

(21) Appl. No.: 13/966,460

(22) Filed: Aug. 14, 2013

Related U.S. Application Data
(60) Provisional application No. 61/683,514, filed on Aug. 15, 2012.
(60) Provisional application No. 61/739,321, filed on Dec. 19, 2012.

(51) Int. Cl. C08K 3/34; C08K 3/40; C08K 5/54

(52) U.S. Cl. CPC C08K 3/34; C08K 5/54; C08K 3/40
USPC 428/457; 524/456; 524/81; 524/494; 427/296; 427/248.1; 427/569; 427/401; 204/192.14; 205/209

(57) ABSTRACT

A thermoplastic composition is described that can be directly coated with a metal according to a metallization process with no intervening base coat formation process necessary. The thermoplastic composition includes a polyarylene sulfide and a filler having a selectively controlled average length and aspect ratio. Molded articles formed of the thermoplastic composition can have an ultra-smooth surface so as to directly accept a metallization coating.

### CROSS-REFERENCE TO RELATED APPLICATIONS

The present application claims filing benefit of U.S. Provisional Patent Application Ser. No. 61/683,514 having a filing date of Aug. 15, 2012 and U.S. Provisional Patent Application Ser. No. 61/739,321 having a filing date of Dec. 19, 2012, both of which are incorporated herein in its entirety.

### BACKGROUND OF THE INVENTION

Metallization, which is the application of a thin coating layer of a metal on a substrate of a different material is a common method used to form a variety of products such as household fixtures, automobile components, and electrical components. For instance, electroplating of chromium onto metal substrates has been used for many years to form automobile parts such as bumpers and wheel covers. With the development of high-performance polymers it has become possible to utilize polymer substrates instead of the traditional metals so as to form products that are lighter weight and less expensive while maintaining the desirable strength characteristics. For instance, polyarylene sulfides have been examined for such applications. Polyarylene sulfides are high-performance polymers that may withstand high thermal, chemical, and mechanical stresses and are beneficially utilized in a wide variety of applications, including applications that include metallization of a molded substrate.

Polyarylene sulfides have often been blended with other materials to improve the characteristics of the product composition. For example, polyarylene sulfides are often compounded with fillers such as glass or mineral fillers to increase strength and stiffness. Moreover, filled polyarylene sulfide compositions can also emit a metal-like sound upon impact, making them particularly attractive for metal replacement materials in a variety of applications. Unfortunately, while inclusion of fillers has enabled the formation of polymeric products that meet or exceed desired mechanical characteristics, the presence of the fillers in the composition can lead to undesirable consequences. For instance, in order to have a smooth metal-like surface, the polymer surface must be ultra-smooth, but the presence of the strength-enhancing fillers in the polymer composition causes the surface to be too rough for metallization. As a result, a base coat must first be applied to the polymeric substrate and then the metallization process can be carried out to apply the metal coating to the base coat. The addition of the base coat adds time and materials to the formation process, leading to more costly products as well as an increased potential for emission of volatile organic compounds (VOC) from the product due to the presence of the base coat.

What is needed in the art is a filled polyarylene sulfide composition that can exhibit desired mechanical characteristics and can be molded to have an ultra-smooth surface so as to accept direct metallization without the need of an intervening base coat between the polymer substrate and the metal coating.

### SUMMARY OF THE INVENTION

According to one embodiment, disclosed is a thermoplastic composition comprising a polyarylene sulfide and a filler that can be directly metallized. The filler can have an average length of less than about 150 micrometers and can have an aspect ratio of from about 6 to about 12. The composition can exhibit a tensile strength of greater than about 75 megapascals (MPa) as determined according to ISO Test No. 527 at 23° C. and a testing speed of 5 mm/min, a notched Izod impact strength of greater than about 15 kilojoules per square meter (kJ/m²) as determined according to ISO Test No. 180 at a temperature of 23° C., and a surface glossiness of greater than about 85 as determined at an incident light angle of 20° relative to the surface.

Also disclosed is a method of forming a metallized product. A method can include forming a thermoplastic composition to form a molded article that includes a thermoplastic composition at a surface and then applying a metal coating directly to a surface of the molded article. The thermoplastic composition can include a polyarylene sulfide and a filler that can have an average length of less than about 150 micrometers and can have an aspect ratio of from about 6 to about 12.

Metallized products including an article formed of the thermoplastic composition and a metal coating directly applied to the article are also disclosed. Products can include, for example, metallized household components including faucets, doorknobs, kick plates, and so forth. Products can include automotive components such as wheel covers, reflectors for auto light fixtures, bumpers, decorative components, etc. Products can also include electrical components such as consumer electronic housings, light fixtures, and so forth.

### BRIEF DESCRIPTION OF THE FIGURES

The present disclosure may be better understood with reference to the following figures:

FIG. 1 schematically illustrates a process as may be used in forming the thermoplastic composition.

FIG. 2 illustrates a kitchen faucet as may be formed with the polyarylene sulfide composition.

FIG. 3 illustrates a bathroom faucet as may be formed with the polyarylene sulfide composition.

FIG. 4 illustrates a light fixture that may include a reflective surface formed according to described processes.

FIG. 5 illustrates an automobile headlight that may include a reflective surface formed according to disclosed processes.

FIG. 6 illustrates a wheel cover as may be formed with the polyarylene sulfide composition.

FIG. 7 is a schematic illustration of an electronic device that may incorporate the multilayer composite.

FIG. 8 is a perspective view of the electronic device of FIG. 7, shown in closed configuration.

FIG. 9A and FIG. 9B are scanning electron microscope (SEM) images of a thermoplastic composition as described herein (FIG. 9B) and a comparison composition (FIG. 9A).

FIG. 10 illustrates a faucet handle and base formed of the thermoplastic composition.

FIG. 11 illustrates a light reflector formed of the thermoplastic composition.

### DETAILED DESCRIPTION

It is to be understood by one of ordinary skill in the art that the present discussion is a description of exemplary embodiments only, and is not intended as limiting the broader aspects of the present disclosure.

The present disclosure is directed in one embodiment to a thermoplastic composition for use in forming metallized products. The thermoplastic composition contains a polyarylene sulfide polymer and a filler. The average length of the filler in the thermoplastic composition is selectively controlled so that it is less than about 150 micrometers, for instance within the range of from about 50 to about 150 micrometers, in some embodiments from about 55 to about 100 micrometers, and in some embodiments from about 60 to about 70 micrometers. The filler also has a narrow aspect ratio. That is, the filler has an aspect ratio that is within a range of from about 6 to about 12, in some embodiments from about 7 to about 11, and in some embodiments from about 8 to about 10. As utilized herein, the term ‘aspect ratio’ generally refers to the ratio of the length of a structure to the greatest width of the structure, with the length and width being generally perpendicular to one another.

Through the use of a polyarylene sulfide polymer and fillers of a certain length and aspect ratio, the present inventors have discovered that the resulting thermoplastic composition is able to achieve a desirable combination of strength and surface smoothness, which enables it to be uniquely suited for direct metallization without the need of any base coat located between the thermoplastic composition and the metal coating formed according to a metallization process. In addition, the inventors have discovered that through selection and control of compounding conditions, the filled polyarylene sulfide can emit a metal sound and have surface and strength characteristics enhancing its use as a replacement for metal materials in a large variety of applications. For example, the thermoplastic composition may be used to form metallized household components, automobile components or electrical components.

When formed from the thermoplastic composition, a molded product can exhibit high strength characteristics in combination with an ultra-smooth surface and a metal-like sound upon impact. For instance, the molded thermoplastic composition can exhibit a tensile strength of greater than about 75 MPa, greater than about 100 MPa, greater than about 110 MPa, greater than about 115 MPa, or greater than about 119 MPa as determined according to ISO Test No. 527 (technically equivalent to ASTM D638) at a testing temperature of 23° C. and a testing speed of 5 mm/min. In addition, the molded composition can exhibit a notched Izod impact strength of greater than about 15 kJ/m², greater than about 20 kJ/m², greater than about 25 kJ/m², or greater than about 27 kJ/m² as determined according to ISO Test No. 180 (technically equivalent to ASTM D 256, Method A) at a temperature of 23° C.

The ultra-smooth surface of the molded thermoplastic composition can be determined by measurement of the surface glossiness. For instance, a gloss meter can be used such as the Micro-TRI-Gloss meter available from BYK Gardner GmbH, though any gloss meter as is known in the art can generally be utilized. The surface glossiness of the molded thermoplastic composition can be greater than about 85, greater than about 100, greater than about 110, greater than about 120, or greater than about 125 as determined at an incident light angle of 20° relative to the surface of the thermoplastic composition.

The fillers used in the thermoplastic composition are not particularly limited with regard to composition. For instance, mineral fillers may be employed in the thermoplastic composition to help achieve the desired mechanical properties and surface smoothness. Clay minerals may be particularly suitable for use in the present invention. Examples of such clay minerals include, for instance, talc (Mg₃Si₄O₁₀(OH)₂), halloysite (Al₂Si₂O₅(OH)₄), kaolinite (Al₂Si₂O₅(OH)₄), montmorillonite (Na, Ca)_{0.33}(Al,Mg)₂Si₄O₁₀(OH)₂.nH₂O), illite ((K,H₃O)(Al,Mg,Fe)₂ (Si,Al)₄O₁₀[(OH)₂,(H₂O)]), vermiculite ((MgFe,Al)₃(Al,Si)₄O₁₀(OH)₂. 4H₂O), palygorskite ((Mg,Al)₂Si₄O₁₀(OH).4(H₂O)), pyrophyllite (Al₂Si₄O₁₀(OH)₂), etc., as well as combinations thereof. In lieu of, or in addition to, clay minerals, still other mineral fillers may also be employed. For example, other suitable silicate fillers may also be employed, such as calcium silicate, aluminum silicate, mica, diatomaceous earth, wollastonite, and so forth. Mica, for instance, may be particularly suitable. There are several chemically distinct mica species with considerable variance in geologic occurrence, but all have essentially the same crystal structure. As used herein, the term “mica” is meant to generically include any of these species, such as muscovite (KAl₂(AlSi₃)O₁₀(OH)₂), biotite (K(Mg,Fe)₃(AlSi₃)O₁₀(OH)₂), phlogopite (KMg₃(AlSi₃)O₁₀(OH)₂), lepidolite (K(Li,Al)₂₋₃(AlSi₃)O₁₀(OH)₂), glauconite (K,Na)(Al,Mg,Fe)₂(Si,Al)₄O₁₀(OH)₂), etc., as well as combinations thereof.

In one embodiment, the fillers can have a high degree of tensile strength relative to their mass. For example, the ultimate tensile strength of the fillers (determined in accordance with ASTM D2101) can be from about 1,000 to about 15,000 MPa, in some embodiments from about 2,000 MPa to about 10,000 MPa, and in some embodiments, from about 3,000 MPa to about 6,000 MPa. High strength fillers can include fibers formed of glass, ceramics (e.g., alumina or silica), aramids (e.g., Kevlar® marketed by E. I. DuPont de Nemours, Wilmington, Del.), polyolefins, polyesters, etc., as well as mixtures thereof. Glass fibers such as E-glass, A-glass, C-glass, D-glass, AR-glass, R-glass, S1-glass, S2-glass, etc., and mixtures thereof can be used.

While the fillers will have a length and aspect ratio as described above, the overall shape of the fillers is not particularly limited. For instance, the fillers can be in the form of generally cylindrical fibers and have circular cross section, or alternatively can have an ovoid or a more plate-like cross sectional shape.

The fillers can include a surface treatment on the surface. By way of example, the fillers can include a surface sizing, a flow modifier, or a combination thereof on the surface.

When present, a surface sizing can include one or more organosilane sizing agents, optionally in conjunction with film forming agents, lubricants, wetting agents, adhesives, antistatic agents and plasticizers, emulsifiers and optionally further additives as are generally known.

A sizing can include one or more alkoxysilane sizing agents such as, without limitation, monoalkoxy silanes, dialkoxysilanes, chorlor silanes, and the like. An alkoxysilane compound may be a silane compound selected from, and without limitation to, vinlyalkoxysilanes, epoxyalkoxysilanes, aminoalkoxysilanes, mercaptoalkoxysilanes, and combinations thereof. Examples of the vinylalkoxysilane that may be utilized include vinyltriethoxysilane, vinyltrimethoxysilane and vinyltris(β-methoxyethoxy)silane. Examples of the epoxyalkoxysilanes that may be used include γ-glycidoxypropyltrimethoxysilane, β-(3,4-epoxycyclohexyl)ethyltrimethoxysilane and γ-glycidoxypropyltriethoxysilane. Examples of the mercaptoalkoxysilanes that may be employed include γ-mercaptopropyltrimethoxysilane and γ-mercaptopropyltriethoxysilane.

Aminosilane sizing compounds are typically of the formula: R³—Si—(R⁴)₃, wherein R³ is selected from the group consisting of an amino group such as NH₂; an aminoalkyl of from about 1 to about 10 carbon atoms, or from about 2 to about 5 carbon atoms, such as aminomethyl, aminoethyl, aminopropyl, aminobutyl, and so forth; an alkene of from about 2 to about 10 carbon atoms, or from about 2 to about 5 carbon atoms, such as ethylene, propylene, butylene, and so forth; and an alkyne of from about 2 to about 10 carbon atoms, or from about 2 to about 5 carbon atoms, such as ethyne, propyne, butyne and so forth; and wherein R⁴ is an alkoxy group of from about 1 to about 10 atoms, or from about 2 to about 5 carbon atoms, such as methoxy, ethoxy, propoxy, and so forth.

In one embodiment, R³ is selected from the group consisting of aminomethyl, aminoethyl, aminopropyl, ethylene, ethyne, propylene and propyne, and R⁴ is selected from the group consisting of methoxy groups, ethoxy groups, and propoxy groups. In another embodiment, R³ is selected from the group consisting of an alkene of from about 2 to about 10 carbon atoms such as ethylene, propylene, butylene, and so forth, and an alkyne of from about 2 to about 10 carbon atoms such as ethyne, propyne, butyne and so forth, and R⁴ is an alkoxy group of from about 1 to about 10 atoms, such as methoxy group, ethoxy group, propoxy group, and so forth. A combination of various aminosilanes may also be included in the sizing.

Some representative examples of aminosilane sizing agents that may be utilized include aminopropyl triethoxy silane, aminoethyl triethoxy silane, aminopropyl trimethoxy silane, aminoethyl trimethoxy silane, ethylene trimethoxy silane, ethylene triethoxy silane, ethyne trimethoxy silane, ethyne triethoxy silane, aminoethylaminopropyltrimethoxy silane, 3-aminopropyl triethoxy silane, 3-aminopropyl trimethoxy silane, 3-aminopropyl methyl dimethoxysilane or 3-aminopropyl methyl diethoxy silane, N-(2-aminoethyl)-3-aminopropyl trimethoxy silane, N-methyl-3-aminopropyl trimethoxy silane, N-phenyl-3-aminopropyl trimethoxy silane, bis(3-aminopropyl)tetramethoxy silane, bis(3-aminopropyl)tetraethoxy disiloxane, and combinations thereof. The amino silane may also be an aminoalkoxysilane, such as γ-aminopropyltrimethoxysilane, γ-aminopropyltriethoxysilane, γ-aminopropylmethyldimethoxysilane, γ-aminopropylmethyldiethoxysilane, N-(β-aminoethyl)-γ-aminopropyltrimethoxysilane, N-phenyl-γ-aminopropyltrimethoxysilane, γ-diallylaminopropyltrimethoxysilane and γ-diallylaminopropyltrimethoxysilane. One suitable amino silane is 3-aminopropyltriethoxysilane which is available from Degussa, Sigma Chemical Company, and Aldrich Chemical Company.

A surface treatment may include one or more functional compounds typically employed as flow modifiers. The functional compounds may be mono-, di-, trifunctional, etc., and may contain one or more reactive functional groups, such as hydroxyl, carboxyl, carboxylate, ester, and primary or secondary amines. One example of such a hydroxyl-functional compound is an aromatic diol, such as hydroquinone, resorcinol, 4,4′-biphenol, etc., as well as combinations thereof. Water is also a suitable hydroxyl-functional compound, and can be used alone or in combination with other hydroxyl-functional compounds. If desired, water can be added in a form that under process conditions generates water. For example, the water can be added as a hydrate that under the process conditions (e.g., high temperature) effectively “loses” water. Such hydrates include alumina trihydrate, copper sulfate pentahydrate, barium chloride dihydrate, calcium sulfate dehydrate, etc., as well as combinations thereof.

In addition to those noted above, still other functional compounds may also be employed as surface treatment agents. For instance, aromatic dicarboxylic acids can be employed. Suitable aromatic dicarboxylic acids for this purpose may include, for instance, terephthalic acid, 2,6-napthalenedicarboxylic acid, isophthalic acid, 4,4′-bibenzoic acid, 2-methylterephthalic acid, etc., as well as combinations thereof. In one particular embodiment, the surface treatment can include a combination of an aromatic diol, hydrate, and aromatic dicarboxylic acid.

A surface treatment composition can be applied to the filler surface according to standard practice. For instance, the filler can be treated with an aqueous surface treatment bath that includes an organosilane sizing agent and/or a flow modifier optionally in typical amounts optionally in conjunction with film forming agents (e.g., polyurethane-based film forming agents), lubricants, antistatic agents, etc. as are generally known.

The relative amount of the fillers in the thermoplastic composition can typically constitute from about 2 wt. % to about 60 wt. %, in some embodiments from about 5 wt. % to about 55 wt. %, and in some embodiments, from about 10 wt. % to about 50 wt. % of the thermoplastic composition.

In addition to fillers, the thermoplastic composition employs at least one polyarylene sulfide polymer. The polyarylene sulfide may be a polyarylene thioether containing repeat units of the formula (I):

—[(Ar¹)ₙ—X]ₘ—[Ar²)ᵢ—Y]ⱼ—[(Ar³)ₖ—Z]ₗ—[(Ar⁴)ₒ—W]ₚ— (I)

wherein Ar¹, Ar², Ar³, and Ar⁴ are the same or different and are arylene units of 6 to 18 carbon atoms; W, X, Y, and Z are the same or different and are bivalent linking groups selected from —SO₂—, —S—, —SO—, —CO—, —O—, —COO— or alkylene or alkylidene groups of 1 to 6 carbon atoms and wherein at least one of the linking groups is —S—; and n, m, i, j, k, l, o, and p are independently zero or 1, 2, 3, or 4, subject to the proviso that their sum total is not less than 2. The arylene units Ar¹, Ar², Ar³, and Ar⁴ may be selectively substituted or unsubstituted. Advantageous arylene systems are phenylene, biphenylene, naphthylene, anthracene and phenanthrene. The polyarylene sulfide typically includes more than about 30 mol %, more than about 50 mol %, or more than about 70 mol % arylene sulfide (—S—) units. In one embodiment the polyarylene sulfide includes at least 85 mol % sulfide linkages attached directly to two aromatic rings.

In one embodiment, the polyarylene sulfide is a polyphenylene sulfide, defined herein as containing the phenylene sulfide structure —(C₆H₄—S)ₙ— (wherein n is an integer of 1 or more) as a component thereof.

The polyarylene sulfide may be synthesized prior to forming the polyarylene sulfide composition, though this is not a requirement of a process, and a polyarylene sulfide can also be purchased from known suppliers. For instance Fortron® polyphenylene sulfide available from Ticona of Florence, Ky., USA can be purchased and utilized as the polyarylene sulfide.

Synthesis techniques that may be used in making a polyarylene sulfide are generally known in the art. By way of example, a process for producing a polyarylene sulfide can include reacting a material that provides a hydrosulfide ion, e.g., an alkali metal sulfide, with a dihaloaromatic compound in an organic amide solvent.

The alkali metal sulfide can be, for example, lithium sulfide, sodium sulfide, potassium sulfide, rubidium sulfide, cesium sulfide or a mixture thereof. When the alkali metal sulfide is a hydrate or an aqueous mixture, the alkali metal sulfide can be processed according to a dehydrating operation in advance of the polymerization reaction. An alkali metal sulfide can also be generated in situ. In addition, a small amount of an alkali metal hydroxide can be included in the reaction to remove or react impurities (e.g., to change such impurities to harmless materials) such as an alkali metal polysulfide or an alkali metal thiosulfate, which may be present in a very small amount with the alkali metal sulfide.

The dihaloaromatic compound can be, without limitation, an o-dihalobenzene, m-dihalobenzene, p-dihalobenzene, dihalotoluene, dihalonaphthalene, methoxy-dihalobenzene, dihalobiphenyl, dihalobenzoic acid, dihalodiphenyl ether, dihalodiphenyl sulfone, dihalodiphenyl sulfoxide or dihalodiphenyl ketone. Dihaloaromatic compounds may be used either singly or in any combination thereof. Specific exemplary dihaloaromatic compounds can include, without limitation, p-dichlorobenzene; m-dichlorobenzene; o-dichlorobenzene; 2,5-dichlorotoluene; 1,4-dibromobenzene; 1,4-dichloronaphthalene; 1-methoxy-2,5-dichlorobenzene; 4,4′-dichlorobiphenyl; 3,5-dichlorobenzoic acid; 4,4′-dichlorodiphenyl ether; 4,4′-dichlorodiphenylsulfone; 4,4′-dichlorodiphenylsulfoxide; and 4,4′-dichlorodiphenyl ketone.

The halogen atom can be fluorine, chlorine, bromine or iodine, and 2 halogen atoms in the same dihalo-aromatic compound may be the same or different from each other. In one embodiment, o-dichlorobenzene, m-dichlorobenzene, p-dichlorobenzene or a mixture of 2 or more compounds thereof is used as the dihalo-aromatic compound.

As is known in the art, it is also possible to use a monohalo compound (not necessarily an aromatic compound) in combination with the dihaloaromatic compound in order to form end groups of the polyarylene sulfide or to regulate the polymerization reaction and/or the molecular weight of the polyarylene sulfide.

The polyarylene sulfide may be a homopolymer or may be a copolymer. By a suitable, selective combination of dihaloaromatic compounds, a polyarylene sulfide copolymer can be formed containing not less than two different units. For instance, in the case where p-dichlorobenzene is used in combination with m-dichlorobenzene or 4,4′-dichlorodiphenylsulfone, a polyarylene sulfide copolymer can be formed containing segments having the structure of formula (II):

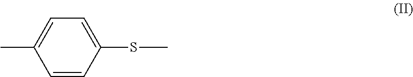

and segments having the structure of formula (III):

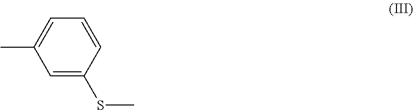

or segments having the structure of formula (IV):

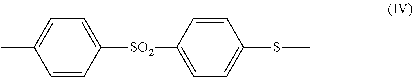

In general, the amount of the dihaloaromatic compound(s) per mole of the effective amount of the charged alkali metal sulfide can generally be from 1.0 to 2.0 moles, from 1.05 to 2.0 moles, or from 1.1 to 1.7 moles. Thus, the polyarylene sulfide can include alkyl halide (generally alkyl chloride) end groups.

A process for producing the polyarylene sulfide can include carrying out the polymerization reaction in an organic amide solvent. Exemplary organic amide solvents used in a polymerization reaction can include, without limitation, N-methyl-2-pyrrolidone; N-ethyl-2-pyrrolidone; N,N-dimethylformamide; N,N-dimethylacetamide; N-methylcaprolactam; tetramethylurea; dimethylimidazolidinone; hexamethyl phosphoric acid triamide and mixtures thereof. The amount of the organic amide solvent used in the reaction can be, e.g., from 0.2 to 5 kilograms per mole (kg/mol) of the effective amount of the alkali metal sulfide.

The polymerization can be carried out by a step-wise polymerization process. The first polymerization step can include introducing the dihaloaromatic compound to a reactor, and subjecting the dihaloaromatic compound to a polymerization reaction in the presence of water at a temperature of from about 180° C. to about 235° C., or from about 200° C. to about 230° C., and continuing polymerization until the conversion rate of the dihaloaromatic compound attains to not less than about 50 mol % of the theoretically necessary amount.

In a second polymerization step, water is added to the reaction slurry so that the total amount of water in the polymerization system is increased to about 7 moles, or to about 5 moles, per mole of the effective amount of the charged alkali metal sulfide. Following, the reaction mixture of the polymerization system can be heated to a temperature of from about 250° C. to about 290° C., from about 255° C. to about 280° C., or from about 260° C. to about 270° C. and the polymerization can continue until the melt viscosity of the thus formed polymer is raised to the desired final level of the polyarylene sulfide. The duration of the second polymerization step can be, e.g., from about 0.5 to about 20 hours, or from about 1 to about 10 hours.

The polyarylene sulfide may be linear, semi-linear, branched or crosslinked. A linear polyarylene sulfide includes as the main constituting unit the repeating unit of —(Ar—S)—. In general, a linear polyarylene sulfide may include about 80 mol % or more of this repeating unit. A linear polyarylene sulfide may include a small amount of a branching unit or a cross-linking unit, but the amount of branching or cross-linking units may be less than about 1 mol % of the total monomer units of the polyarylene sulfide. A linear polyarylene sulfide polymer may be a random copolymer or a block copolymer containing the above-mentioned repeating unit.

A semi-linear polyarylene sulfide may be utilized that may have a cross-linking structure or a branched structure provided by introducing into the polymer a small amount of one or more monomers having three or more reactive functional groups. For instance between about 1 mol % and about 10 mol % of the polymer may be formed from monomers having three or more reactive functional groups. Methods that may be used in making semi-linear polyarylene sulfide are generally known in the art. By way of example, monomer components used in forming a semi-linear polyarylene sulfide can include an amount of polyhaloaromatic compounds having 2 or more halogen substituents per molecule which can be utilized in preparing branched polymers. Such monomers can be represented by the formula R′Xₙ, where each X is selected from chlorine, bromine, and iodine, n is an integer of 3 to 6, and R′ is a polyvalent aromatic radical of valence n which can have up to about 4 methyl substituents, the total number of carbon atoms in R′ being within the range of 6 to about 16. Examples of some polyhaloaromatic compounds having more than two halogens substituted per molecule that can be employed in forming a semi-linear polyarylene sulfide include 1,2,3-trichlorobenzene, 1,2,4-trichlorobenzene, 1,3-dichloro-5-bromobenzene, 1,2,4-triiodobenzene, 1,2,3,5-tetrabromobenzene, hexachlorobenzene, 1,3,5-trichloro-2,4,6-trimethylbenzene, 2,2′,4,4′-tetrachlorobiphenyl, 2,2′,5,5′-tetra-iodobiphenyl, 2,2′,6,6′-tetrabromo-3,3′,5,5′-tetramethylbiphenyl, 1,2,3,4-tetrachloronaphthalene, 1,2,4-tribromo-6-methylnaphthalene, and the like, and mixtures thereof.

Following polymerization, the polyarylene sulfide may be washed with liquid media. For instance, the polyarylene sulfide may be washed with water, acetone, N-methyl-2-pyrrolidone, a salt solution, and/or an acidic media such as acetic acid or hydrochloric acid prior to combination with other components while forming the mixture. The polyarylene sulfide can be washed in a sequential manner that is generally known to persons skilled in the art, for instance with an organic solvent that will not decompose the polyarylene sulfide. Washing with an acidic solution or a salt solution may reduce the sodium, lithium or calcium metal ion end group concentration from about 2000 ppm to about 100 ppm. A polyarylene sulfide can be subjected to a hot water washing process. The temperature of a hot water wash can be at or above about 100° C., for instance higher than about 120° C., higher than about 150° C., or higher than about 170° C. In one embodiment, organic solvent washing can be combined with hot water washing and/or warm water washing. When a high-boiling-point organic solvent such as N-methylpyrrolidone is used, the residual organic solvent can be removed by washing with water or warm water after the organic solvent washing, and distilled water or deionized water can be used for this washing.

The polymerization reaction apparatus for forming the polyarylene sulfide is not especially limited, although it is typically desired to employ an apparatus that is commonly used in formation of high viscosity fluids. Examples of such a reaction apparatus may include a stirring tank type polymerization reaction apparatus having a stirring device that has a variously shaped stirring blade, such as an anchor type, a multistage type, a spiral-ribbon type, a screw shaft type and the like, or a modified shape thereof. Further examples of such a reaction apparatus include a mixing apparatus commonly used in kneading, such as a kneader, a roll mill, a Banbury mixer, etc. Following polymerization, the molten polyarylene sulfide may be discharged from the reactor, typically through an extrusion orifice fitted with a die of desired configuration, cooled, and collected. Commonly, the polyarylene sulfide may be discharged through a perforated die to form strands that are taken up in a water bath, pelletized and dried. The polyarylene sulfide may also be in the form of a strand, granule, or powder.

The thermoplastic composition may include the polyarylene sulfide component (which also encompasses a blend of polyarylene sulfides) in an amount from about 10 wt. % to about 99 wt. % by weight of the composition, for instance from about 20% wt. % to about 90 wt. % by weight of the composition.

The polyarylene sulfide may be of any suitable molecular weight and melt viscosity, generally depending upon the final application intended for the polyarylene sulfide composition and the processing methodology to be used in forming the composition. For instance, the polyarylene sulfide may be a low viscosity material, having a melt viscosity of less than about 200 poise, a medium viscosity polyarylene sulfide, having a melt viscosity of from about 200 poise to about 1000 poise, or a high melt viscosity polyarylene sulfide, having a melt viscosity of greater than about 1,000 poise. In one embodiment, the polyarylene sulfide may have a number average molecular weight greater than about 25,000 g/mol, or greater than about 30,000 g/mol, and a weight average molecular weight greater than about 60,000 g/mol, or greater than about 65,000 g/mol. Melt viscosity may be determined in accordance with ISO Test No. 11443 at a shear rate of 1200 s⁻¹ and at a temperature of 310° C.

In addition to the polyarylene sulfide and the filler, the thermoplastic composition can include one or more additives as are generally known in the art. For example, the composition can include antimicrobials, pigments, lubricants, antioxidants, stabilizers, surfactants, waxes, flow promoters, solid solvents, and other materials added to enhance properties and/or the processibility of the composition. Such optional materials may be employed in a composition in conventional amounts.

The components of the thermoplastic composition may be melt processed according to techniques known in the art. For example, the components of the composition may be melt-kneaded in a single-screw or multi-screw extruder at a temperature of from about 250° C. to about 320° C. In one embodiment, the composition may be melt processed in an extruder that includes multiple temperature zones. For instance, the composition may be melt processed in an extruder that includes a temperature zone that is maintained at a temperature of between about 250° C. and about 320° C.

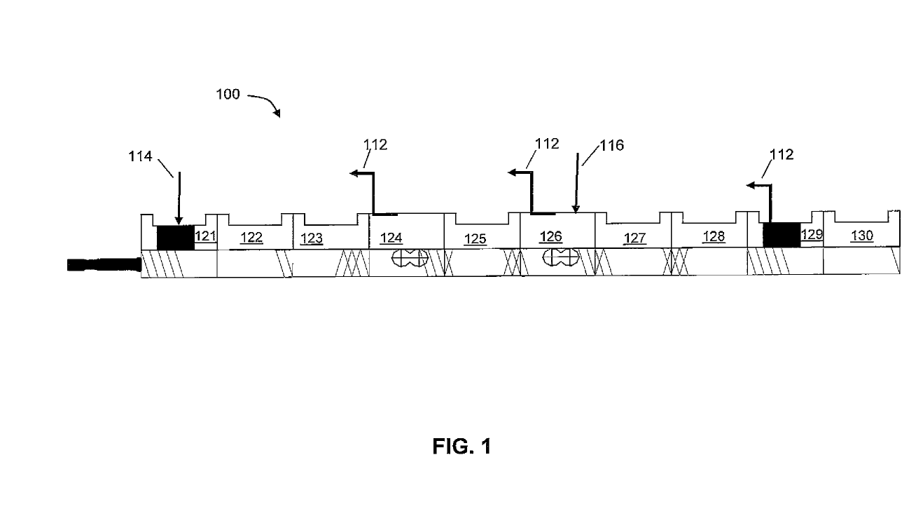

FIG. 1 illustrates a schematic of a process that can be used in forming the thermoplastic composition. As illustrated, the components of the composition may be melt-kneaded in a melt processing unit such as an extruder 100. Extruder 100 can be any extruder as is known in the art including, without limitation, a single, twin, or multi-screw extruder, a co-rotating or counter rotating extruder, an intermeshing or non-intermeshing extruder, and so forth. In one embodiment, the composition may be melt processed in an extruder 100 that includes multiple zones or barrels. In the illustrated embodiment, extruder 100 includes 10 barrels numbered 121-130 along the length of the extruder 100, as shown. Each barrel 121-130 can include feed lines 114, 116, vents 112, temperature controls, etc. that can be independently operated. A general purpose screw design can be used to melt process the composition. By way of example, a thermoplastic composition may be melt mixed using a twin screw extruder such as a WLE or Werner & Phladerer co-rotating fully intermeshing twin screw extruder.

In forming the thermoplastic composition, a polyarylene sulfide can be fed to the extruder 100 at a main feed throat 114. For instance, the polyarylene sulfide may be fed to the main feed throat 114 at the first barrel 121 by means of a volumetric or gravimetric feeder. The polyarylene sulfide can be melted and mixed with the other components of the composition as it progresses through the extruder 100.

While the fillers can be introduced to the composition at any time, it is typically desired to introduce the fillers such that they can be well dispersed and distributed throughout the composition. While not wishing to be bound to any particular theory, it is believed that dispersal and distribution of the fillers throughout the composition can be enhanced when the polymer melt viscosity is relatively high. Accordingly, in one embodiment, the fillers can be added to the composition downstream of the addition of the polyarylene sulfide. In one embodiment, the fillers may be added at a location downstream from the point at which the polyarylene sulfide is supplied, but yet prior to the melting section. In another embodiment, the fillers may be added at a location downstream from the point at which the polyarylene sulfide becomes molten. For instance, in the illustrated embodiment, the polyarylene sulfide can be added to the extruder 100 at the main feed throat 114 and a second feed line 116 at barrel 126 can be utilized for addition of the fillers. In this embodiment, the fillers can be added to the thermoplastic composition at a point after the polyarylene sulfide has melted and initial mixing has occurred.

To help encourage dispersion and distribution of the fillers throughout the melt, a variety of different parameters may be selectively controlled. For example, the ratio of the length (“L”) to diameter (“D”) of a screw of the melt processing unit may be selected to achieve an optimum balance between throughput and filler dispersion and distribution. For example, the L/D value after the point at which the fillers are supplied may be controlled to encourage dispersion and distribution of the fillers. More particularly, the screw can have a blending length (“L_{B}”) that is defined from the point at which the fillers are supplied to the unit to the end of the screw, the blending length generally being less than the total length of the screw. In one embodiment, it may be desirable to add the fillers before the polyarylene sulfide is melted, which means that the L_{B}/D ratio would be relatively high. However, too high of a L_{B}/D ratio could result in degradation of the polymer. Therefore, the L_{B}/D ratio of the screw after the point at which the fillers are supplied is typically from about 3 to about 20, in some embodiments from about 4 to about 18, and in some embodiments, from about 5 to about 16.

If desired, one or more distributive and/or dispersive mixing elements may be employed within the mixing section of the melt processing unit. Suitable distributive mixers for single screw extruders may include, for instance, Saxon, Dulmage, Cavity Transfer mixers, etc. Likewise, suitable dispersive mixers may include Blister ring, Leroy/Maddock, CRD mixers, etc. As is well known in the art, the mixing may be further increased in aggressiveness by using pins in the barrel that create a folding and reorientation of the polymer melt, such as those used in Buss Kneader extruders, Cavity Transfer mixers, and Vortex Intermeshing Pin mixers.

The speed of the screw can also be controlled to improve the characteristics of the thermoplastic composition. For instance the screw speed can be about 400 rpm or less, in one embodiment, such as between about 200 rpm and about 350 rpm, or between about 225 rpm and about 325 rpm. In one embodiment, the compounding conditions can be balanced so as to provide a thermoplastic composition that exhibits improved impact and tensile properties. For example, the compounding conditions can include a screw design to provide mild, medium, or aggressive screw conditions. For example, system can have a mildly aggressive screw design in which the screw has one single melting section on the downstream half of the screw aimed towards gentle melting and distributive melt homogenization. A medium aggressive screw design can have a stronger melting section upstream from the filler feed barrel focused more on stronger dispersive elements to achieve uniform melting. Additionally it can have another gentle mixing section downstream to mix the fillers. This section, although weaker, can still add to the shear intensity of the screw to make it stronger overall than the mildly aggressive design. A highly aggressive screw design can have the strongest shear intensity of the three. The main melting section can be composed of a long array of highly dispersive kneading blocks. The downstream mixing section can utilize a mix of distributive and intensive dispersive elements to achieve uniform dispersion of all type of fillers. The shear intensity of the highly aggressive screw design can be significantly higher than the other two designs.

In one embodiment, a system can include a medium to aggressive screw design with relatively mild screw speeds (e.g., between about 200 rpm and about 300 rpm) and downstream addition of the fillers, so as to improve distribution of the fillers throughout the composition and provide a thermoplastic composition with excellent physical characteristics.

The thermoplastic composition may be shaped to form a desired article that may then be coated according to a metallization process. Shaping processes for forming an article of the thermoplastic composition can include, without limitation, extrusion, injection molding, blow-molding, thermoforming, foaming, compression molding, hot-stamping, pultrusion, and so forth. Shaped articles that may be formed may include household items, automotive components, electrical components, and so forth.

By way of example, FIG. 2 schematically illustrates a kitchen faucet 10 that can include one or more components formed of the thermoplastic composition. As can be seen, the faucet includes a spout 14, control handle 24, valve body 18, and spray nozzle 44. The various components are mounted on a base 16 and in fluid communication with connectors 36 in the form of pipes, hoses, or so forth. One or more components of the faucet 10 can be formed from the thermoplastic composition, for instance according to an injection molding process. By way of example, one or more of the spout 14; one or more elements of the spray nozzle 44 such as rings, handle, spout, etc.; the housing of the valve body 18 and the control handle 24 can be molded from the thermoplastic composition according to an injection molding process. The thermoplastic molded component can then be utilized as a substrate for a metallization process.

As is known in the art, an injection molding process can include two main phases—i.e., an injection phase and holding phase. During the injection phase, the mold cavity is completely filled with the molten polymer composition. The holding phase is initiated after completion of the injection phase in which the holding pressure is controlled to pack additional material into the cavity and compensate for volumetric shrinkage that occurs during cooling. After the shot has built, it can then be cooled. Once cooling is complete, the molding cycle is completed when the mold opens and the article is ejected, such as with the assistance of ejector pins within the mold.

Following initial molding, the formed article can be subjected to a metallization process. Metallizing can be used to coat any suitable metal onto the surface of the molded article, and the metal(s) of the metallized coating are not particularly limited. For instance, the metal coating can include chrome, aluminum, copper, nickel, gold, tin, silver, zinc, titanium, zirconium, etc., as well as metal alloys as are generally known.

Metallization can be carried out according to any standard process including, without limitation, vacuum deposition, vapor deposition, ionic plasma deposition, electroplating, sputtering, electroless plating, and so forth. By way of example, the molded article can be immersed in a solution that includes an oxidizing agent, such as a strong acid solution (e.g., hydrochloric acid). Following, the molded article can be immersed in a solution that includes a metallization catalyst, for instance a palladium catalyst solution including a tin catalyst stabilizer (e.g., an aqueous solution including PdCl₂ and SnCl₂) so as to apply the catalyst to the surface. Alternatively, the molded product can be dipped into a single solution that includes the oxidizing agent and the metallization catalyst, rather than two separate steps, as is known. The catalyst can be activated, for instance according to a thermal activation process in which the molded product is held in the catalyst bath at a temperature of between about 25° C. and about 40° C. for a period of between about 10 minutes and about 30 minutes. Finally, the molded article is dipped in an electroless plating solution including the desired metal to deposit the metal on the activated surface of the molded article. Beneficially, the metallization process can be carried out without any surface pretreatment steps such as application of a base coat, mechanical treatment such as sandblasting or grinding, treatment with a reducing agent, or the like.

In another example, an electroplating method can be utilized, for instance for deposition of a chrome/nickel surface. Chrome/nickel plating baths are well known, conventional and commercially available. A typical chrome/nickel plating bath contains chromic acid or salts thereof, and catalyst ion such as sulfate or fluoride. The catalyst ions can be provided by sulfuric acid or its salts and fluosilicic acid. The baths also may contain nickel sulfate, nickel chloride and boric acid. These baths can include a number of well-known and conventionally used compounds such as leveling agents, brighteners, and the like. The baths may be operated at a temperature of about 45° C. to about 50° C. Typically in chrome/nickel plating a current density of about 150 amps per square foot, at about five to nine volts is utilized.

Physical vapor deposition methods such as cathodic arc evaporation, reactive cathodic arc evaporation, sputtering, reactive sputtering, etc., can also be used for metallizing the molded article. By way of example, in a sputtering process, the molded article is placed in a vacuum chamber and an inert gas such as argon is introduced to the chamber following evacuation of air. The gas is ionized and ions are accelerated in the vacuum toward the cathode target of the desired metallic material. When the ions hit the target, individual metal atoms are “knocked off” and deposited on the substrate surface. Sputtering is a low energy process as compared to other coating processes such as ion plasma deposition and can be even more attractive due to the improved adhesion of the polyarylene sulfide composition disclosed herein. Beneficially, there is no need for formation of a base coat for adhesion of the metal to the polyarylene sulfide surface.

In a cathodic arc evaporation technique, an electric arc that is generally on the order of several hundred amperes is struck on the surface of the metal cathode and the arc vaporizes the cathode material. The vaporized material then condenses on the molded article to form the metal coating.

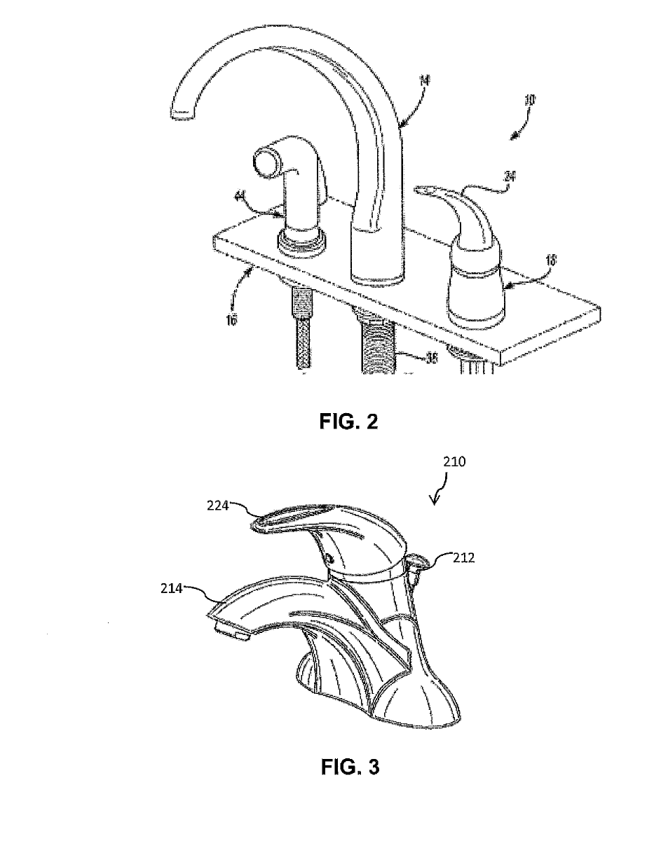

Household products that can be formed of the metallized thermoplastic composition are not limited to kitchen faucets. For instance, FIG. 3 illustrates a bathroom faucet 210 include a spout 214, handle 224 and drain control 212. One or all of these components of the bathroom faucet 210 can be formed of the metallized thermoplastic composition. Other household items that can be formed of the metallized thermoplastic composition can include, without limitation, door knobs, door locks, kick plates, furnishings (e.g., tables, chairs, etc.), shelving, shower heads, towel racks, shower door frames, and so forth.

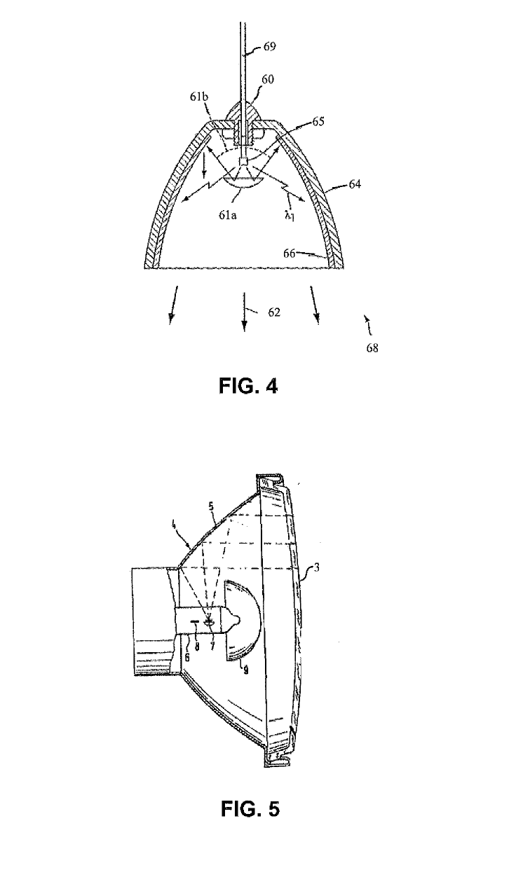

Metallized components can include light fixtures such as that illustrated in FIG. 4 in which is shown a schematic cross-sectional representation of a lighting system that includes a hanging, or pendant, lighting fixture 68. The hanging fixture 68 is suspended by a cable 69 which is secured to the shade 64 by a threaded mount 60. The mount 60 can include a cable clamp (not shown) for maintaining a fixed relation between the cable 69 and mount 60. In the embodiment illustrated the metallized layer 66 is provided on an inner surface of the shade 64 that is formed from the thermoplastic composition. A light source 65, e.g., an LED can be directly connected to the cable 69 or a connector arrangement can be provided as part of the mount. A parabolic reflector 61 that can also be formed of the metallized thermoplastic composition can be provided in one of two alternative arrangements indicated as 61a and 61b in FIG. 4, the latter of which the reflector is indicated by a broken line. In the first arrangement the reflector 61a is provided below the light source 65 and is arranged to reflect emitted radiation from the light source 65 toward the shade 64 and thereby prevent direct emission of radiation from the light. Such an arrangement is particularly advantageous to ensure a uniform distribution of emitted radiation 62 from the lighting fixture. In the second arrangement the reflector 61b is provided above the light source 65 and is arranged to reflect radiation from the open end of the lighting fixture.

Metallized automotive components can also be beneficially formed of the thermoplastic composition such as, without limitation, bumpers, reflectors, door handles, decorative stripping, and so forth. For instance, FIG. 5 illustrates a light 4 for use in a vehicle. The light 4 includes diffuser disk 3, a reflector 5, and a parabolic bulb reflector 9 for a lamp 6 that includes a low-beam filament 7 and a high-beam filament 8. In general, one or both of the reflectors 5, 9 can be formed of the metallized thermoplastic composition. During use, light from the filaments 7, 8 will be reflected by use of the bulb reflector 9 and the reflector 5 so as to direct the light through the diffuser, as indicated by the dashed lines of the figure. While light 4 is illustrated as a headlight, it should be understood that a vehicle light encompassed herein can include turn signal indicators, back-up lights, hazard lights, running lights, interior lights, and so forth.

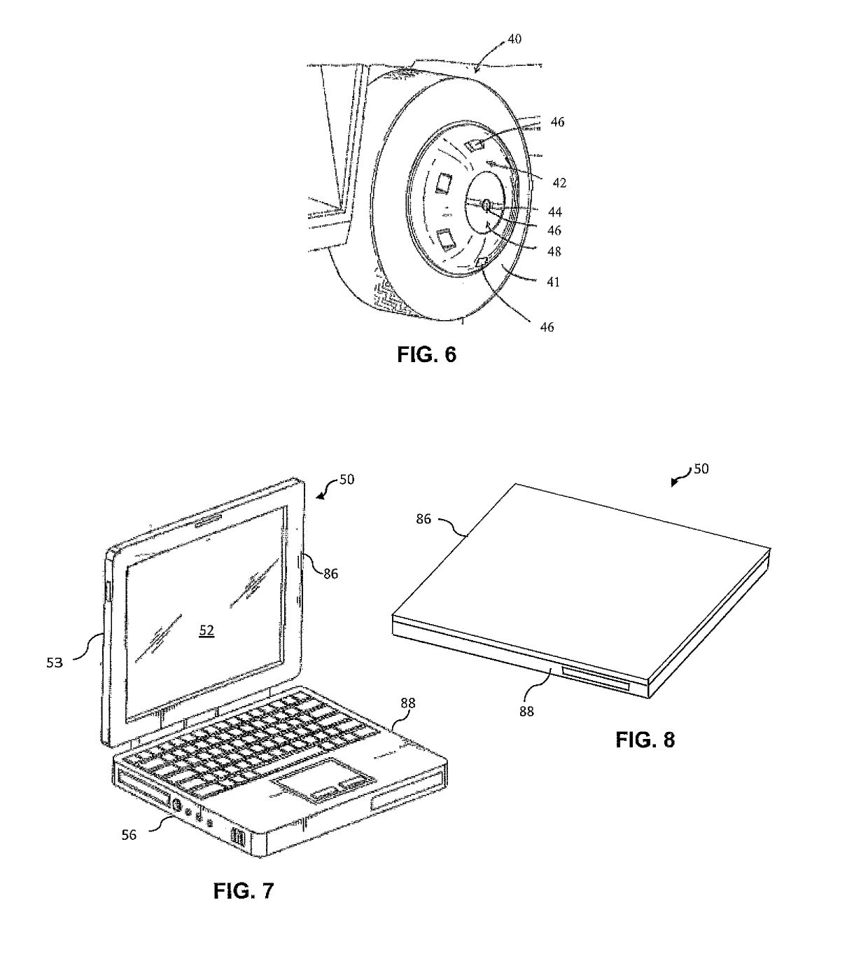

Another example of a metallized automotive component that can be formed of the thermoplastic composition is a wheel cover, a representative embodiment of which is illustrated in FIG. 6. FIG. 6 is a perspective view of a tire/wheel arrangement 40 comprising a wheel cover 42 including a bridge section 44. For instance the bridge section can include a pressure sensor 46 and an exhaust port 48 in the wheel cover 42 as is generally known. The wheel cover can be molded from the thermoplastic composition and metallized on one or both sides with a desired metal coating, for instance a chrome or nickel coating. The wheel cover 42 may also include a plurality of fasteners 46 located about the exterior of the wheel cover 42. The wheel cover 42 is fastened to the wheel rim (not shown in FIG. 6) about a vehicle tire 41 by fasteners 46 for removably attaching the wheel cover 42 to the wheel rim according to standard practice.

Metallized products can include electronic components. Examples of electronic components that may employ such a metallized part include, for instance, cellular telephones, laptop computers, small portable computers (e.g., ultraportable computers, netbook computers, and tablet computers), wrist-watch devices, pendant devices, headphone and earpiece devices, media players with wireless communications capabilities, handheld computers (also sometimes called personal digital assistants), remote controllers, global positioning system (GPS) devices, handheld gaming devices, battery covers, speakers, camera modules, integrated circuits (e.g., SIM cards), etc.

Wireless electronic devices may be particularly suitable for incorporation of components formed of the metallized thermoplastic composition. Examples of suitable wireless electronic devices may include a desktop computer or other computer equipment, a portable electronic device, such as a laptop computer or small portable computer of the type that is sometimes referred to as “ultraportables.” In one suitable arrangement, the portable electronic device may be a handheld electronic device. Examples of portable and handheld electronic devices may include cellular telephones, media players with wireless communications capabilities, handheld computers (also sometimes called personal digital assistants), remote controls, global positioning system (“GPS”) devices, and handheld gaming devices. The device may also be a hybrid device that combines the functionality of multiple conventional devices. Examples of hybrid devices include a cellular telephone that includes media player functionality, a gaming device that includes a wireless communications capability, a cellular telephone that includes game and email functions, and a handheld device that receives email, supports mobile telephone calls, has music player functionality and supports web browsing.

Referring to FIGS. 7-8, one particular embodiment of an electronic device 50 is shown as a portable computer. The electronic device 50 includes a display member 53, such as a liquid crystal diode (LCD) display, an organic light emitting diode (OLED) display, a plasma display, or any other suitable display. In the illustrated embodiment, the device is in the form of a laptop computer and so the display member 53 is rotatably coupled to a base member 56. It should be understood, however, that the base member 56 is optional and can be removed in other embodiments, such as when device is in the form of a tablet portable computer. Regardless, in the embodiment shown in FIGS. 7-8, the display member 53 and the base member 56 each contain a housing 86 and 88, respectively, for protecting and/or supporting one or more components of the electronic device 50. The housing 86 may, for example, support a display screen 52 and the base member 56 may include cavities and interfaces for various user interface components (e.g., keyboard, mouse, and connections to other peripheral devices). The metallized thermoplastic composition can be used to form all or a portion of the housing 86 and/or 88. When the device is a tablet portable computer, for example, the housing 88 may be absent and the thermoplastic composition may be used to form all or a portion of the housing 86.

Although not expressly shown, the device 50 may also contain circuitry as is known in the art, such as storage, processing circuitry, and input-output components. Wireless transceiver circuitry in circuitry may be used to transmit and receive radio-frequency (RF) signals. Communications paths such as coaxial communications paths and microstrip communications paths may be used to convey radio-frequency signals between transceiver circuitry and antenna structures. A communications path may be used to convey signals between the antenna structure and circuitry. The communications path may be, for example, a coaxial cable that is connected between an RF transceiver (sometimes called a radio) and a multiband antenna.

Embodiments of the present disclosure are illustrated by the following examples that are merely for the purpose of illustration of embodiments and are not to be regarded as limiting the scope of the invention or the manner in which it may be practiced. Unless specifically indicated otherwise, parts and percentages are given by weight.

### Test Methods

Tensile Properties: Tensile strength and tensile elongation are tested according to ISO Test No. 527 (technically equivalent to ASTM D638). Measurements are made on a test strip sample having a length of 80 mm, thickness of 10 mm, and width of 4 mm. Testing temperature is 23° C., and testing speed is 5 mm/min.

Izod Notched Impact Strength: Notched Izod properties are tested according to ISO Test No. 180 (technically equivalent to ASTM D256, Method A). This test is run using a Type A notch. Specimens are cut from the center of a multi-purpose bar using a single tooth milling machine. The testing temperature is 23° C.

Izod Unnotched Impact Strength: Unnotched Izod properties were determined according to ISO Test No. 180/1 U. Specimens were cut from the center of a multi-purpose bar using a single tooth milling machine. Testing temperature was 23° C.

Surface Glossiness: A gloss meter is used to measure the glossiness of a surface. Glossiness readings are taken at two different locations of the surface at an incident light angle of 20° relative to the surface of the part, with three repeat measurements at each location. The average of the readings is taken for calculating the glossiness. Any suitable gloss meter may be used to measure glossiness, such as Micro-TRI-Gloss from BYK Gardner GmbH.

Maximum load at break: Multi-axial impact tests were carried out according to ASTM D3763 (equivalent to ISO Test Method No. 6603) at 23° C. and 11 ft/sec (3.4 m/sec). According to the test method, a four inch by four inch plaque of the multilayer composite material is mounted in the grips of the mechanical testing machine. The maximum load of the material can be determined from the maximum force carried before failure.

Screw aggressiveness: Three screw aggressiveness designs were utilized:

Mildly aggressive: One single melting section on the downstream half of the screw.

Medium aggressive: A melting section upstream from the filler feed barrel and another gentle mixing section downstream to mix the fillers.

Highly aggressive: The main melting section is composed of a long array of highly dispersive kneading blocks and the downstream mixing section utilizes a mix of distributive and intensive dispersive elements.

### Example 1

Components used to form samples included the following:

Polyarylene Sulfide:
Fortron® 0205B4 polyphenylene sulfide (PPS) available from Ticona Engineering Polymers of Florence, Ky.

Fillers:
Glass fiber—910a10c fiberglass available from OCV™ having a 10 μm average diameter and an average length of 170 μm after compounding
Mineral filler 1 (MF1)—Nyglos® 4W wollastonite particles having an average width of 7 μm and an average length of 63 μm
Mineral filler 2 (MF2)—Nyglos® 8 wollastonite particles having an average width of 12 μM and an average length of 156 μm
Mineral filler 3 (MF3)—Proprietary mineral filler having a length of less than 63 μm

Surface treatments:
Sizing 1 (S1)—proprietary surface sizing
Sizing 2 (S2)—silane added during compounding of the composition

Materials were compounded using a 25 mm WLE twin screw extruder (L/D˜38) using a screw designed for compounding filler with polyphenylene sulfide, 250 rpm screw speed and 401b/hr total throughput rate. Temperatures ranged from 280° C. to 310° C. and were scaled appropriately for the given barrel sections.

Sample Compositions are summarized in the table below. Amounts are provided as weight percentages unless otherwise noted.

| Sample No. | 1 | 2 | 3 | 4 | 5 | 6 |
|---|---|---|---|---|---|---|
| PPS | 60 | 60 | 60 | 60 | 60 | 60 |
| Glass | 40 | | | | | |
| MF1 | — | Proprietary | 40 | 40 | 40 | 30 |
| | | blend to | | | | |
| | | 40% total | | | | |
| MF2 | — | — | — | — | — | 10 |
| MF3 | — | Proprietary | — | — | — | |
| | | blend to | | | | |
| | | 40% total | | | | |
| S1 | No | yes | yes | no | no | no |
| S2 | No | no | no | yes | no | yes |

Tensile bars were injection molded to ISO 527-1 specifications according to standard ISO conditions. Temperatures were 313° C., 316° C., 321° C. and 317° C. (rear to nozzle) with a mold temperature of 135° C. and an injection speed of 275 mm/s.

Test results of the molded products are shown in the table, below:

| Sample | Tensile | Notched Izod | Surface |
|---|---|---|---|
| No. | Strength (MPa) | (kJ/m²) | Glossiness |
| 1 | 104 | 3 | 65.2 |
| 2 | 79.01 | 12.6 | 127 |
| 3 | 99.47 | 18.3 | 103.7 |
| 4 | 119.97 | 27.7 | 129.4 |
| 5 | 123.34 | 27.6 | 83.9 |
| 6 | 114 | 5.9 | 118.2 |

As can be seen, Sample No. 4, having a silane sized filler with a length of 63 μm and an aspect ratio of 9 gave the best combination of tensile strength, notched Izod impact strength, and surface glossiness.

### Example 2

A thermoplastic composition as described herein was formed and tested for physical characteristics. Sample Compositions are summarized in the table below. Comparative Samples included commercial products as described in the table.

| Sample | |
|---|---|
| No. | Composition |
| 7 | Albis Plastics Tedur ® L9560 - 50% mineral filled |
| | polyphenylene sulfide |
| 8 | Albis Plastics Tedur ® L9523 - 60% glass fiber/mineral filled |
| | polyphenylene sulfide |
| 9 | Albis Plastics Tedur ® L9561 - 60% glass fiber/mineral filled |
| | polyphenylene sulfide |
| 10 | DIC Corporation FZ 8600 - glass fiber/mineral filled |
| | polyphenylene sulfide |
| 11 | A 40% mineral filled polyphenylene sulfide including a |
| | proprietary mineral filler |
| 12 | A 40% mineral filled polyphenylene sulfide including |
| | Nyglos ® 4W wollastonite particles having |
| | an average width of 7 μm and an average length |
| | of 63 μm |

Physical properties for the Samples are provided in the table below. The properties of the commercially available products were obtained from publically available product information (see, e.g., www.matweb.com).

| | Tensile Strength | Tensile Elongation | Unnotched Izod | |
|---|---|---|---|---|
| Sample No. | (MPa) | (%) | Impact Strength | |
| 7 | 50 | 0.50 | 14 | kJ/m² |
| 8 | 105 | 0.80 | | |
| 9 | 85 | 1.20 | | |
| 10 | 100 | 1.1 | 260 | kJ/m |
| 11 | 85 | 0.8 | 14 | kJ/m² |
| 12 | 125 | 1.1 | 28 | kJ/m² |

As can be seen, Sample 12, which includes the fillers as described herein, had improved physical characteristics as compared to the other samples.

### Example 3

Samples were formed including 60 wt. % of a polyphenylene sulfide (Fortron® 0205B4 polyphenylene sulfide (PPS) available from Ticona Engineering Polymers of Florence, Ky.), and 40 wt. % of a mineral filler (Nyglos® 4W wollastonite particles having an average width of 7 μm and an average length of 63 μm).

Compositions were compounded using a 25 mm WLE twin screw extruder (L/d˜38). Compounding conditions were varied with regard to the aggressiveness of the screw, the screw speed, and the location of filler addition to the unit.

Screw aggressiveness was noted by number in which (1) designates mildly aggressive screw design, (2) designates medium aggressive screw design, and (3) designates highly aggressive screw design.

Sample compounding conditions are summarized in the table below. The filler locations are reported as weight percentage of the thermoplastic composition.

| | | Screw | Throughput | Filler | Filler at |
|---|---|---|---|---|---|
| Sample | Screw | Speed | Rate | at Main | Barrel 6 |
| No. | Aggressiveness | (rpm) | (lb/hour) | Feed (wt. %) | (wt. %) |
| 13 | 1 | 250 | 120 | 10 | 30 |
| 14 | 1 | 400 | 120 | 10 | 30 |
| 15 | 1 | 250 | 120 | — | 40 |
| 16 | 1 | 400 | 120 | — | 40 |
| 17 | 3 | 250 | 120 | — | 40 |
| 18 | 3 | 400 | 120 | — | 40 |
| 19 | 3 | 250 | 120 | 10 | 30 |
| 20 | 3 | 400 | 120 | 10 | 30 |
| 21 | 2 | 200 | 120 | — | 40 |
| 22 | 2 | 300 | 120 | — | 40 |
| 23 | 2 | 400 | 120 | — | 40 |

Tensile bars were injection molded to ISO 527-1 specifications according to standard ISO conditions. Temperatures were 313° C., 316° C., 321° C. and 317° C. (rear to nozzle) with a mold temperature of 135° C. and an injection speed of 275 mm/s.

Test results of the molded products are shown in the table, below:

| Sample | Maximum load | Tensile Strength | Tensile Elongation |
|---|---|---|---|
| No. | at break (lb-f) | (MPa) | (%) |
| 13 | 206 | 92.5 | 1.26 |
| 14 | 219.6 | 95.5 | 1.28 |
| 15 | 212 | 86.9 | 1.12 |
| 16 | 211.6 | 90.24 | 1.18 |
| 17 | 247.9 | 125.45 | 1.1 |
| 18 | 185 | 123.94 | 1.08 |
| 19 | 218.6 | 118.58 | 1.17 |
| 20 | 140.3 | 103.36 | 0.74 |
| 21 | 262.3 | 106.2 | 0.92 |
| 22 | 231.9 | 115.3 | 1.06 |
| 23 | 204.1 | 113.1 | 1.04 |

As can be seen, Sample No. 17, which was compounded with a more aggressive screw at relatively mild compounding conditions and downstream addition of filler gave the best balance of impact and tensile properties.

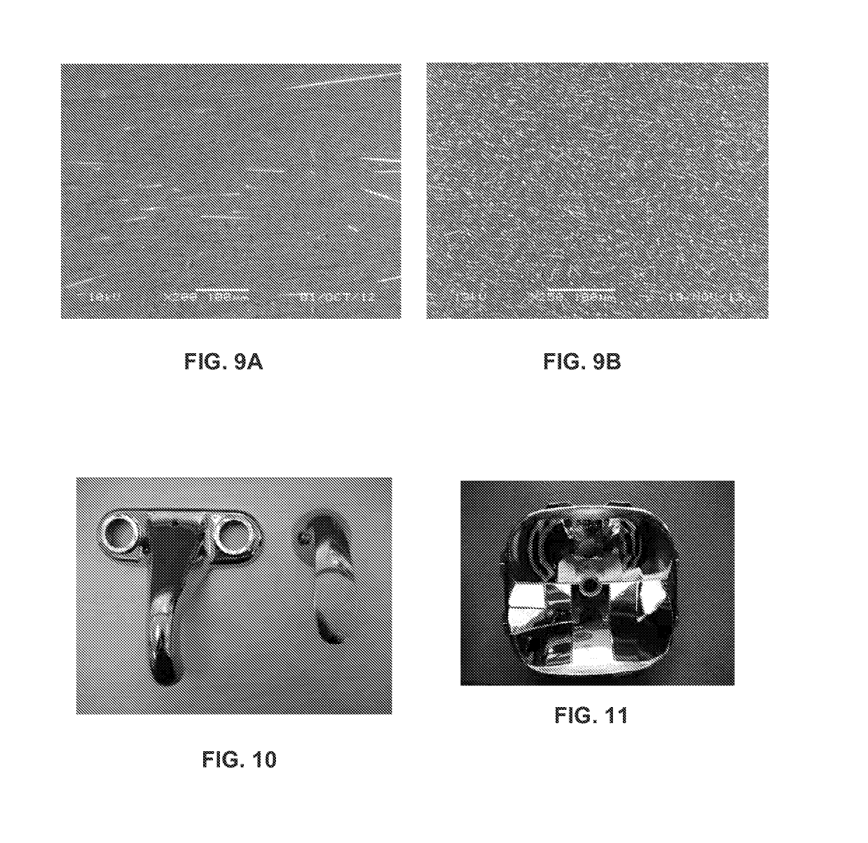

FIG. 9A is a scanning electron microscope (SEM) image of a typical commercial grade 40% glass filled PPS material. FIG. 9B is an SEM image of Sample No. 17. As can be seen the typical glass filled material includes large fibers that will affect the surface smoothness, whereas Sample No. 17 includes much smaller filler materials providing for a much smoother surface.

Sample No. 17 was utilized to form metallized products. The thermoplastic composition was molded and metallized to form a faucet handle and base (FIG. 10) and a lamp reflector (FIG. 11). The products exhibited look, feel and sound of a metal.

While certain representative embodiments and details have been shown for the purpose of illustrating the subject invention, it will be apparent to those skilled in this art that various changes and modifications may be made therein without departing from the scope of the subject invention.

What is claimed is:

1. A thermoplastic composition comprising:
a polyarylene sulfide; and
a filler having an average length of less than about 150 micrometers and an aspect ratio of from about 6 to about 12; wherein
the thermoplastic composition exhibiting a tensile strength of greater than about 75 MPa as determined according to ISO Test No. 527 at 23° C., a notched Izod impact strength of greater than about 15 kilojoules per square meter as determined according to ISO Test No. 180 at a temperature of 23° C., and a surface glossiness of greater than about 85 as determined at an incident light angle of 20°.

2. The thermoplastic composition of claim 1, wherein the polyarylene sulfide is a polyphenylene sulfide.

3. The thermoplastic composition of claim 1, wherein the filler has an average length of from about 50 micrometers to about 150 micrometers.

4. The thermoplastic composition of claim 1, wherein the filler comprises a surface treatment.

5. The thermoplastic composition of claim 4, wherein the surface treatment comprises a surface sizing, a flow modifier, or a combination thereof.

6. The thermoplastic composition of claim 5, wherein the surface sizing comprises an organosilane sizing agent.

7. The thermoplastic composition of claim 1, wherein the filler has an average length of from about 55 to about 100 micrometers and an aspect ratio of from about 7 to about 11.

8. The thermoplastic composition of claim 1, wherein the filler is a mineral filler.

9. The thermoplastic composition of claim 1, wherein the filler is a fiber.

10. The thermoplastic composition of claim 9, wherein the fiber is a glass fiber.

11. The thermoplastic composition of claim 1, wherein the thermoplastic composition includes the filler in an amount of from about 2 wt. % to about 60 wt. % of the composition.

12. A metallized product comprising:
an article that includes a thermoplastic composition at a surface of the article, the thermoplastic composition including a polyarylene sulfide and a filler, wherein the filler has an average length of less than about 150 micrometers and has an aspect ratio of from about 6 to about 12; and
a metal coating directly applied to the surface of the article.

13. The metallized product of claim 12, wherein the metallized product is a faucet.

14. The metallized product of claim 12, wherein the metallized product is a household product.

15. The metallized product of claim 12, wherein the metallized product is an automotive component.

16. The metallized product of claim 15, wherein the metallized product is a reflector.

17. The metallized product of claim 15, wherein the metallized product is a wheel cover.

18. The metallized product of claim 12, wherein the metallized product is an electronic component.

19. The metallized product of claim 18, wherein the metallized product is a component of a telephone or a computer.

20. The metallized product of claim 18, wherein the metallized product is a component of a wireless device.

21. The metallized product of claim 12, wherein the metal coating comprises chrome, aluminum, copper, nickel, gold, tin, silver, zinc, titanium, zirconium, or a metal alloy.

22. A method for forming a metallized product, the method comprising:
melt processing a polyarylene sulfide with a filler to form a thermoplastic composition, wherein the filler has an average length of less than about 150 microns and has an aspect ratio of from about 6 to about 12;
forming the thermoplastic composition to form a molded article that includes the thermoplastic composition at a surface of the molded article; and
applying a metal coating directly to a surface of the molded article.

23. The method according to claim 22, wherein the filler comprises a surface treatment.

24. The method according to claim 23, wherein the surface treatment comprises a surface sizing, a flow modifier, or a combination thereof.

25. The method according to claim 24, wherein the surface sizing comprises an organosilane sizing agent.

26. The method according to claim 22, wherein the molded article is formed according to a process selected from the group consisting of an extrusion process, an injection molding process, a blow-molding process, a thermoforming process, a foaming process, a compression molding process, a hot-stamping process, a pultrusion process, and combinations thereof.

27. The method according to claim 22, wherein the metal coating is applied directly to the surface of the thermoplastic composition according to a process selected from the group consisting of vacuum deposition, vapor deposition, ionic plasma deposition, electroplating, sputtering and electroless plating.

28. The method according to claim 22, wherein the step of melt processing the polyarylene sulfide with the filler comprises adding the polyarylene sulfide to a melt processing unit at an addition point and adding the filler to the melt processing unit downstream of the polyarylene sulfide addition point.

29. The method according to claim 22, wherein the step of melt processing the polyarylene sulfide with the filler comprises adding the polyarylene sulfide and the filler to a melt processing unit having a mixing screw with a blending length to diameter ratio of from about 3 to about 20.

30. The method according to claim 22, wherein the step of melt processing the polyarylene sulfide with the filler comprises adding the polyarylene sulfide and the filler to a melt processing unit having one or more distributive and/or dispersive mixing elements in a mixing section of the melt processing unit.

31. The method according to claim 22, wherein the step of melt processing the polyarylene sulfide with the filler comprises adding the polyarylene sulfide and filler to a melt processing unit having a mixing screw, the mixing screw operating at speed of about 400 rpm of less.
